(19) United States
(12) Patent Application Publication
(10) Pub. No.: US 2016/0280001 A1
(43) Pub. Date: Sep. 29, 2016

(54) UNSTITCHED SEAM PRODUCTS AND METHOD OF MANUFACTURE

(71) Applicant: GUR-PRYM AGENCY LTD., Givat Shmuel (IL)

(72) Inventor: Abraham Gurkevitch, Givat Shmuel (IL)

(21) Appl. No.: 15/075,249

(22) Filed: Mar. 21, 2016

(30) Foreign Application Priority Data
Mar. 29, 2015 (IL) 238014

(51) Int. Cl. B44C 1/16; A41B 9/04; A41B 9/10; A41B 9/00

(52) U.S. Cl. CPC B44C 1/16; A41B 9/001; A41B 9/04; A41B 9/10

(57) ABSTRACT

The present invention provides methods and unstitched heat-transferable patterned seam products for replacing a sewn seam in a fabric product, the seam product including an unstitched heat-transferable patterned seam portion and at least one carrier element, wherein the unstitched heat-transferable patterned seam portion is adapted to be placed upside down over a garment edge and heat-transferred to the garment edge to provide a seamed patterned garment edge.

### FIELD OF THE INVENTION

The present invention relates generally to unstitched seam products and methods, and more specifically to products and methods for efficient garment manufacture.

### BACKGROUND OF THE INVENTION

Most garments are produced according to a design pattern, which may be cut out in paper, then in fabric pieces. Thereafter, the fabric pieces are sewn together to form the garment. This manufacturing process is slow and expensive. There is therefore a need to find new cheaper and more efficient processes for manufacturing garments.

Some patent publications in the field include US2003019373A, which discloses a method for manufacturing an item of underwear or an item of sportswear by applying a medium, running in lengths and strengthening the fabric of the item of clothing, on to a cut-out piece of material, wherein application of the medium is done by the silk screen printing method or the adhesive coating method and in a first step of the method the printed length is structured in such a way that it substantially corresponds to the later outer contour of the item of clothing and in a second step of the method the printed fabric is cut in the area of the printed length.

US2005003736A discloses garments having one or more laser-cured polymeric regions, methods of making, and laser-cured polymers are provided. The polymeric regions can have cure levels that different from one another. Further, the polymeric regions can have a variable cure level within the individual region.

US2005198722A discloses an article of swimwear includes a swimsuit body having at least one aperture configured to encircle a portion of a swimmer's body when the swimsuit is worn by a user, and a resilient seal secured about the at least one aperture.

U.S. Pat. No. 7,906,189 discloses a method for labeling fabrics, such as fabric garments, and a heat-transfer label (311) well-suited for use in said method. In one embodiment, the heat-transfer label (311) comprises (i) a support portion (313), the support portion (313) comprising a carrier (315) and a release layer (317); (ii) a wax layer (319), the wax layer over coating the release layer (317); and (iii) a transfer portion (321), the transfer portion (321) comprising an adhesive layer (323) printed directly onto the wax layer (319) and an ink design layer (325) printed directly onto the adhesive layer (323). Each of the adhesive layer (323) and the ink design layer includes a PU resin. The ink design layer may be screen printed onto the adhesive layer (323) or may be printed onto the adhesive layer (323) using thermal transfer printing, ink jet printing or laser printing.

There is still a need for improved garments and methods of manufacture thereof.

### SUMMARY OF THE INVENTION

It is an object of some aspects of the present invention to provide unstitched seams and products with unstitched seams.

It is an object of some aspects of the present invention to provide unstitched seams and products with unstitched seams.

In some embodiments of the present invention, improved methods and apparatus are provided for efficient garment manufacture.

In some embodiments of the present invention, improved methods and apparatus are provided for efficient garment manufacture by sealing edges of underwear and sportswear with elastic textile transfer made of glue and water based ink.

In some embodiments of the present invention, improved methods and apparatus are provided for efficient garment manufacture by providing an unstitched seam and garment edge design in one product by using a heat transfer.

There is thus provided according to an embodiment of the present invention, an unstitched heat-transferable patterned seam product for replacing a sewn seam in a fabric product, the seam product including an unstitched heat-transferable patterned seam portion and at least one carrier element, wherein the unstitched heat-transferable patterned seam portion is adapted to be placed upside down over a garment edge and heat-transferred to the garment edge to provide a seamed patterned garment edge.

Additionally, according to an embodiment of the present invention, the the unstitched elastic heat-transferable patterned seam portion includes;
a) a lower ink layer including flock; and
b) an upper adhesive layer.

Additionally, according to an embodiment of the present invention, the ink layer includes at least one color of ink.

Furthermore, according to an embodiment of the present invention, the ink layer includes at least two colors of ink.

Further, according to an embodiment of the present invention, the ink layer includes at least three colors of ink.

Additionally, according to an embodiment of the present invention, the lower ink layer includes at least one thermochromic ink.

Moreover, according to an embodiment of the present invention, the upper adhesive layer includes at least one heat-activatable adhesive.

Further, according to an embodiment of the present invention, the upper adhesive layer has a thickness of about 10 to 400 microns. According to some embodiments, the glue layer is 50-70 microns.

Yet further, according to an embodiment of the present invention, the lower ink layer has a thickness of about 10 to 800 microns.

Additionally, according to an embodiment of the present invention, the heat-activatable adhesive layer includes at least one of a polyester adhesive resin, a polyamide resin, and a polyurethane adhesive resin.

Additionally, according to an embodiment of the present invention, the lower ink layer includes at least one cross-linked PU ink.

Moreover, according to an embodiment of the present invention, the carrier element includes a release layer selected from wax, a non-stick polymer, a non-wax, non-silicone, release material and combinations thereof.

Additionally, according to an embodiment of the present invention, the lower ink layer is screen printed onto the carrier element.

Moreover, according to an embodiment of the present invention, the lower ink layer is screen printed onto the carrier element in at least two separate screen printings.

Additionally, according to an embodiment of the present invention, the at least one carrier element forms part of the seam product.

Furthermore, according to an embodiment of the present invention, the carrier element forms part of the seam product.

There is thus provided according to another embodiment of the present invention, a method for forming a garment including;
a) cutting a piece of material to into a shape; and
b) heat transferring at least one unstitched heat-transferable patterned seam product according to claim 1 onto the shape, thereby forming the garment.

Additionally, according to an embodiment of the present invention, steps a) and b) are repeated.

Furthermore, according to an embodiment of the present invention, the method further includes;
c) sewing the pieces of material together in at least one place.

Importantly, according to an embodiment of the present invention, there is provided a seamless garment, formed according to the method described herein.

Further importantly, according to an embodiment of the present invention, there is provided a seamed garment, formed according to the method described herein.

The present invention will be more fully understood from the following detailed description of the some embodiments thereof, taken together with the drawings.

### BRIEF DESCRIPTION OF THE DRAWINGS

The invention will now be described in connection with certain some embodiments with reference to the following illustrative figures so that it may be more fully understood.

With specific reference now to the figures in detail, it is stressed that the particulars shown are by way of example and for purposes of illustrative discussion of the some embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified flow chart of a method for forming an unstitched seam product, in accordance with an embodiment of the present invention;

FIG. 2A is a simplified pictorial illustration of a vertical cross-section of an unstitched seam product, in accordance with an embodiment of the present invention;

FIG. 2B is a simplified pictorial illustration of an upper view of an unstitched seam product, in accordance with an embodiment of the present invention;

FIG. 2C is a simplified pictorial illustration of an upper view of cut piece of fabric, in accordance with an embodiment of the present invention;

FIG. 3 is a simplified flow chart of a method for forming a seamed garment, in accordance with an embodiment of the present invention;

FIG. 4 is a simplified pictorial illustration of the components of a seamed garment, in accordance with an embodiment of the present invention;

FIG. 5 is a simplified flow chart of a method for forming a seamless garment, in accordance with an embodiment of the present invention;

FIG. 6 is a simplified pictorial illustration of the components of a seamless garment, in accordance with an embodiment of the present invention;

FIG. 7 is a simplified pictorial illustration of a side view of a roll of an unstitched seam product, in accordance with an embodiment of the present invention;

FIG. 8 is a simplified pictorial illustration of an upper view of another unstitched seam product, in accordance with an embodiment of the present invention; and

FIG. 9 is a simplified pictorial illustration of a side view of an unstitched seam product used in a garment, in accordance with an embodiment of the present invention.

In all the figures similar reference numerals identify similar parts.

### DETAILED DESCRIPTION OF EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

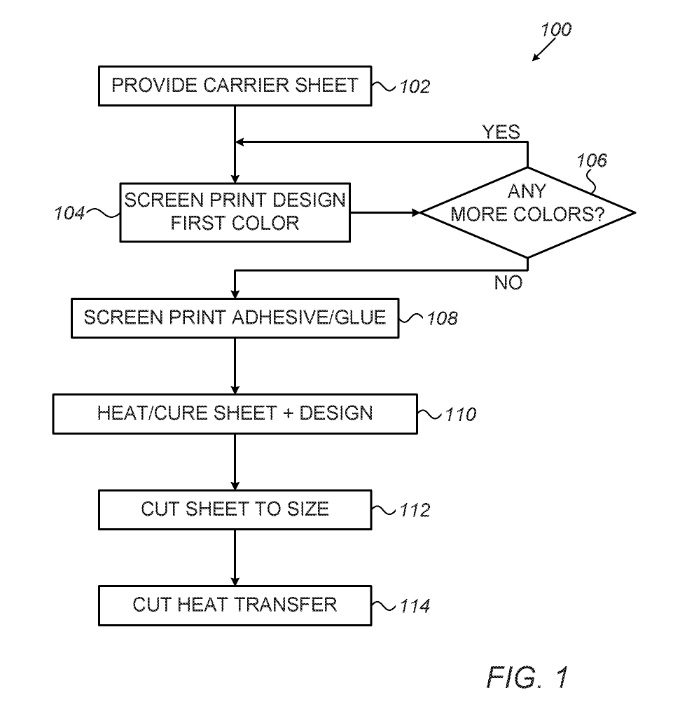

Reference is now made to FIG. 1, which is a simplified flow chart 100 of a method for forming an unstitched seam product, in accordance with an embodiment of the present invention.

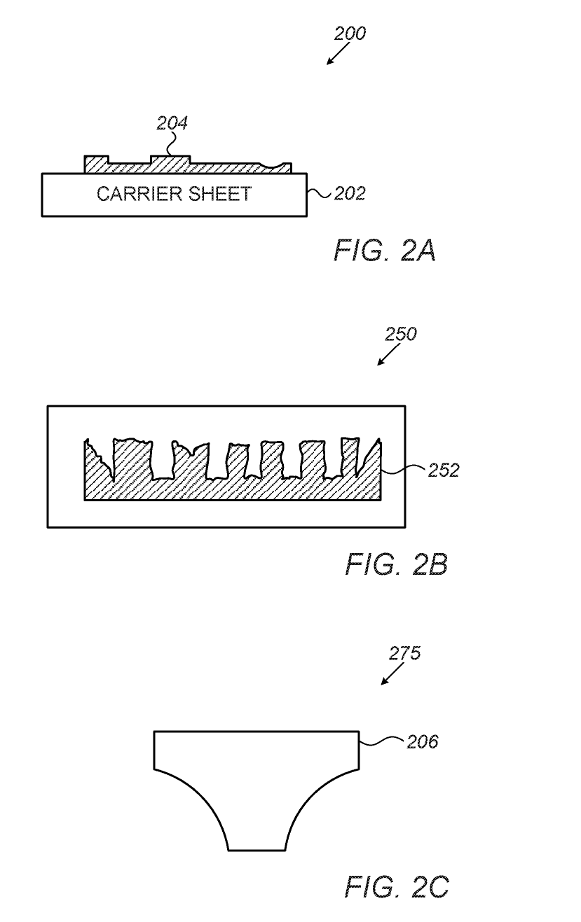

In a providing a carrier sheet step 102, a carrier sheet 202 (FIG. 2A) is provided. The carrier sheet may be made of paper, cardboard, a polymeric material and combinations thereof.

Thereafter, in a first screen printing step 104 a first screen print design color is printed onto the carrier sheet. If the product comprises many colors, then checking step 106 is performed and step 104 is repeated once, typically, for each color.

The color may comprise any suitable color components for screen printing, known in the art. For example, the color may comprise a polyurethane (PU) resin that has been cross-linked using at least one cross-linker, said at least one cross-linker preferably having more than one functional group per molecule, said functional group being at least one of carbodiimide, alkoxymethyl and methylol. An example of a suitable ink composition for use in making ink design layer 225 comprises 144 parts Permutex RU-74-059 (Stahl), 80 parts PT 312 (See, 54 parts EDA51 (Resina PU 1200) (Sef), 54 parts BEMICOAT PCS (Schmits), 45.28 parts pigments Doloran 17/0 (Eckart), 25 parts 5000-31-04 (Chromazone), for further details, the detailed description and drawings of which are incorporated here by reference.

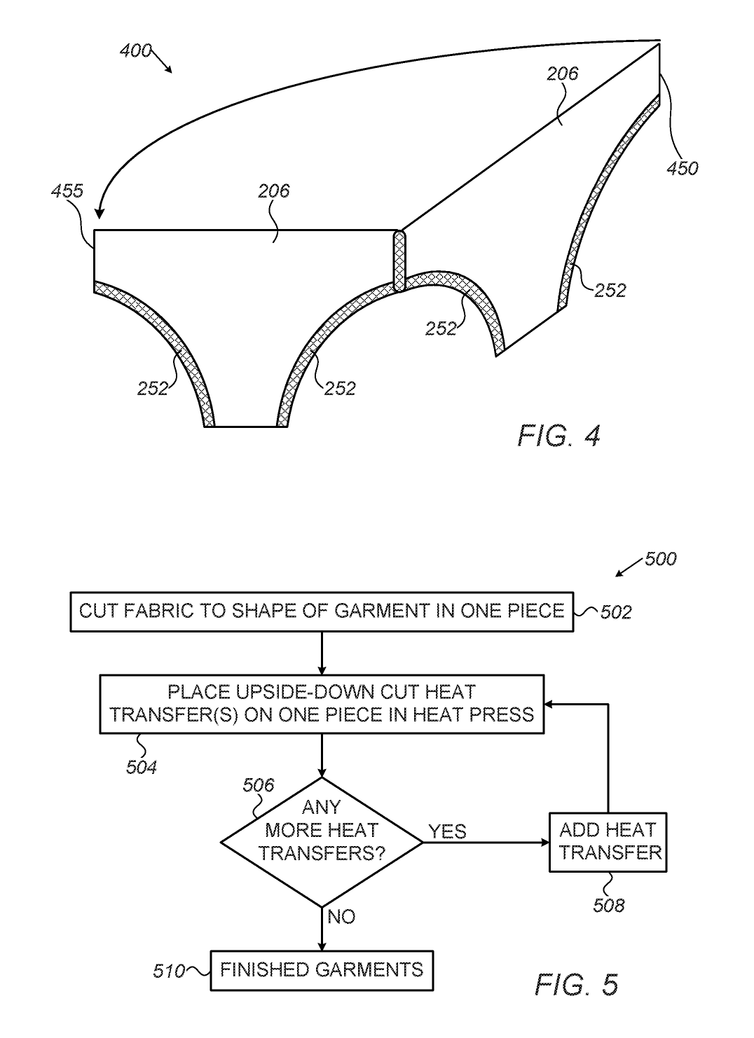

If no further colors are required in checking step 106, then a second screen printing step 108 is performed, in which an adhesive is screen printed on the color or colors. It should be understood that there may be one or several screen printing steps of the adhesives. The description is intended to be illustrative and not limiting. Furthermore, the carrier sheet may comprise several layers, one or more of which may be transferred in the curing step, together with the heat transfer to be bonded to the garment (such as garment 400, FIG. 4).

Thereafter, in a curing step 110, the screen printed color(s) and adhesive(s) are cured. Some typical, non-limiting curing conditions are 150-180° C. at 2-3 atm pressure for 15-20 sec.

The cured sheet is cut to shape in a cutting step 112. A second cutting step 114 may optionally be performed to form a final product 200 (FIG. 2A).

FIG. 2A is a simplified pictorial illustration of a vertical cross-section of an unstitched seam product 200, in accordance with an embodiment of the present invention. The product comprises the carrier sheet 202 with a cured cut product 204 thereupon. The carrier sheet may be made of paper, a synthetic polymer, a fabric, mixed fibers, a rigid material, a flexible material, cotton, wool, hemp, bamboo, polyester, rayon, nylon, a synthetic fabric and combinations thereof.

FIG. 2B is a simplified pictorial illustration of an upper view 250 of the unstitched edge seam product 252, in accordance with an embodiment of the present invention. As can be seen in the drawing, the product may have a two-dimensional shape. It also has a third dimension of variable/constant thickness, as is seen in FIG. 2A. The edge seam product may comprise a lace-like edging, alphanumeric markings, a pattern, a logo, a trademark, a symbol, a decoration, a picture, a pattern and combinations thereof. The edge seam product may comprise flock. Flock consists of synthetic fibers that look like tiny hairs. Flock print feels somewhat velvet and a bit elevated. The length of the fibers can vary in thickness which co-determines the appearance of the flocked product. The flock may be added at step 104 (FIG. 1). A combination of flock materials may be introduced to produce edge seam products of different feels, appearances and thickness. The flock may comprise natural or synthetic fibers.

According to some embodiments of the present invention, the edge seam product is elastic. It may be stretched to 100-120%, 120-150%, 150-200%, or 200 to 500% of its original size. It may be stretched lengthwise and/or widthwise.

FIG. 2C is a simplified pictorial illustration of an upper view 275 of a cut piece of fabric 206, in accordance with an embodiment of the present invention. The fabric may be any suitable material or fabric, known in the art, such as, but not limited to; cotton, rayon, nylon, wool, silk, hemp, paper, leather, suede, rubber, a polymeric material, a synthetic material, a natural material and combinations thereof.

The cut piece of fabric is typically an elastic fabric, used for making a piece of underwear, swimwear, a garment or the like. According to some embodiments of the present invention, the fabric may be stretched to 100-120%, 120-150%, 150-200%, or 200 to 500% of its original size. It may be stretched lengthwise and/or widthwise.

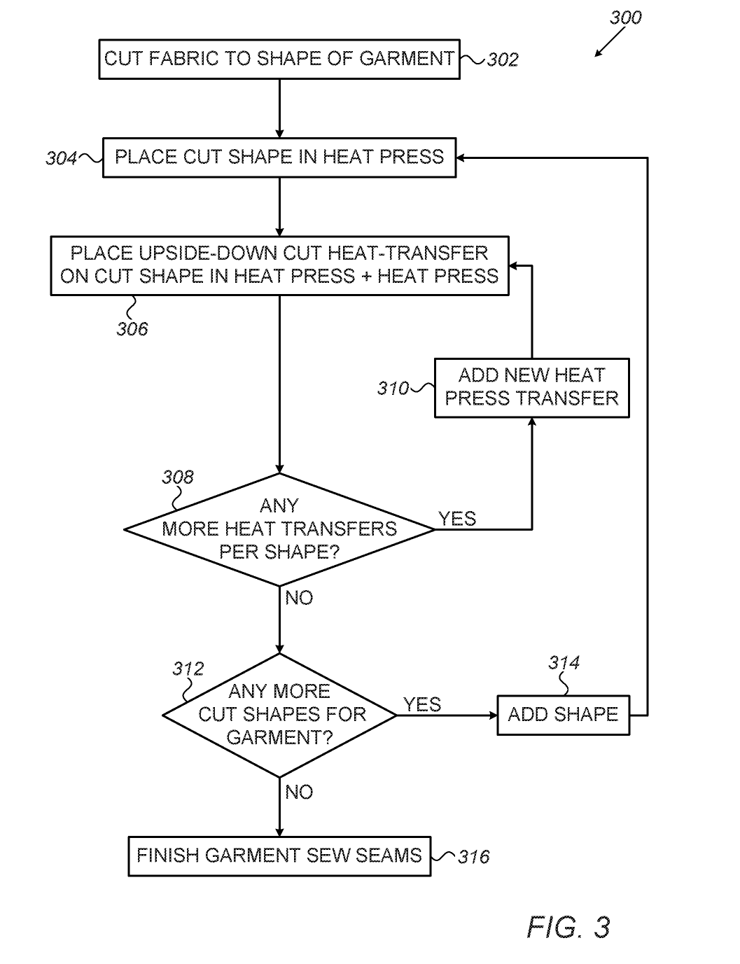

According to some embodiments, the fabric is typically of a weight of 50-100 g/m², 100-150 g/m², or 150-250 g/m². Reference is now made to FIG. 3, which is a simplified flow chart 300 of a method for forming a seamed garment, in accordance with an embodiment of the present invention.

In a fabric cutting step 302, one or more pieces of the fabric are cut to shape. The one or more pieces are placed in in a heat press, such as a Framis model (Framis Italia S.p.A, Via del Commercio, 8—Gaggiano (MI) Italy), in a placing step 304. Thereafter, at least one upside down heat transfer 252 is placed upside-down on the fabric piece 206 in a second placing step and they are heat pressed together, in a heat pressing step 306.

In a checking step 308, it is checked whether there are any further heat transfers per garment shape. If yes, another heat transfer 252 is added to the garment in an adding step 310. If no, a second checking step is performed to see if any further garment fabric shapes/pieces are required. If yes, another shape is added in a fabric shape adding step 314. Thereafter steps 304-312 are repeated.

If, in checking step 312, there are no additional pieces, then the garment is finished by adding/buttons/sewed seams or any other finishing step 316.

It should be understood from FIG. 3, that a garment, such as a pair of panties, can be made from this method. If the thickness of the piece of fabric 206 (FIG. 2C) is 0.05-0.1 mm, 01.-0.2 mm, 0.2-0.4 mm. The final garment may have a thickness of an additional 0.01-0.05 mm, 0.05-0.1 mm or 0.1-0.2 mm at a leg seam 460. Thus, contrary to prior art leg-seamed panties, these transfer panties will not be visible, when worn under a skirt, a dress, pants, jeans or trousers, due to their low leg seam thickness.

Reference is now made to FIG. 4, which is a simplified pictorial illustration of the components of a seamed garment 400, in accordance with an embodiment of the present invention. The seamed garment comprises four identical unstitched seam products 252, and two identical or similar fabric pieces. The garment is finished by sewing seams 450, 455 together. Optionally, there may be further unstitched seam products on the waistline of the garment (not shown).

Reference is now made to FIG. 5, which is a simplified flow chart 500 of a method for forming a seamless garment, in accordance with an embodiment of the present invention.

In a fabric cutting step 502, one or more pieces of the fabric are cut to shape. The one piece is placed in in a heat press, such as a Framis machine, in a placing step 504 and at least one upside down heat transfer 800 (FIG. 8) is placed upside-down on the fabric and they are heat pressed together.

In a checking step 506, it is checked whether there are any further heat transfers per garment shape. If yes, another heat transfer 800 is added to the garment in an adding step 508. If no, the garment is completed, such as in the production of seamless panties.

A final finishing step 510 may include finished by adding/buttons or any other finishing step.

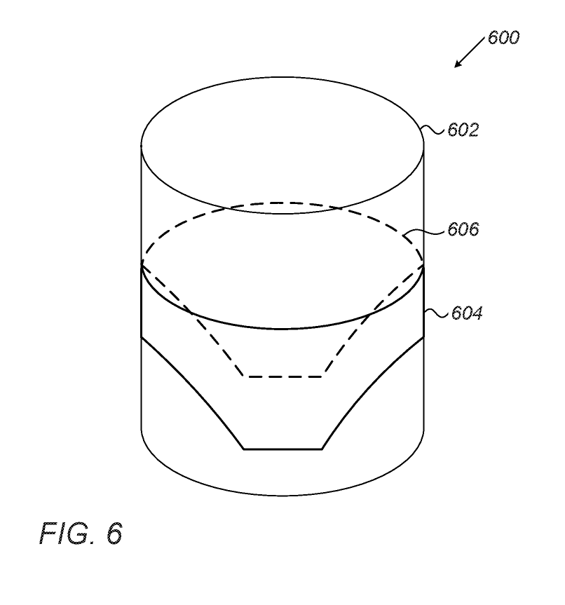

Turning to FIG. 6, there is seen a simplified pictorial illustration of the components of a seamless garment 604 (seamless panties) on a cylindrical form 602. The seamless garment comprises one piece having a front side 601 and a rear side 603, in accordance with an embodiment of the present invention.

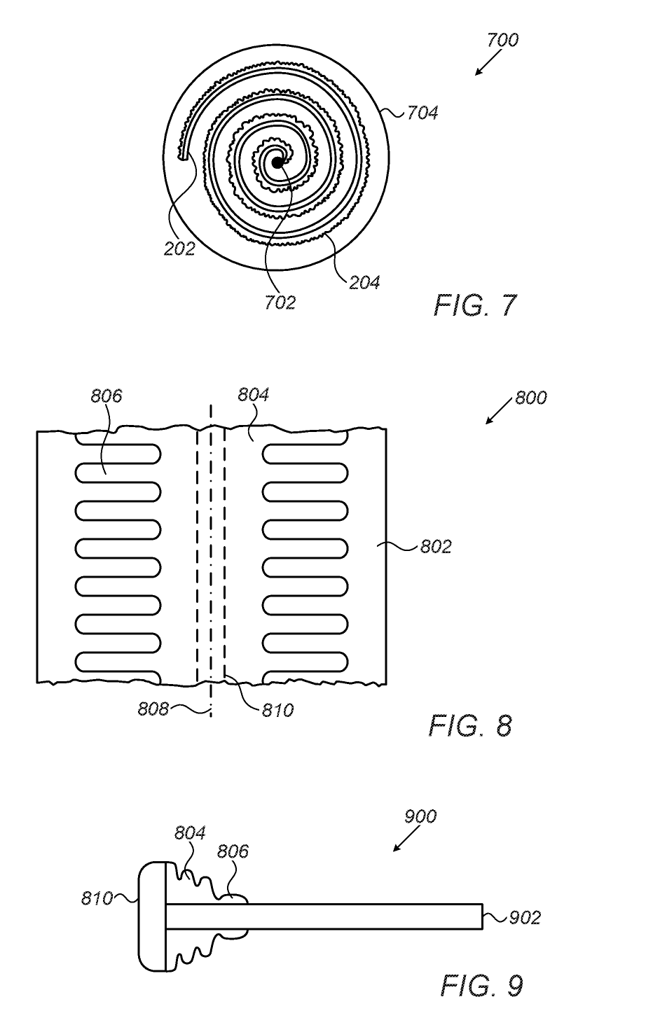

FIG. 7 shows a simplified pictorial illustration of a side view of a roll 700 of an unstitched seam product, in accordance with an embodiment of the present invention. The roll is typically placed on a cardboard/wooden/metallic cylindrical carrier 702. A carrier sheet 202 carries a transfer 204 and is optionally housed in a cylindrical box 704.

FIG. 8 is a simplified pictorial illustration of an upper view of another unstitched seam product 800, in accordance with an embodiment of the present invention. Product 800 is symmetrical about a longitudinal axis 808. It comprises a patterned edge 806 on both sides and inner material 804 and central material 810. The product is held on a carrier sheet 802. The product forms a double-sided finish to a garment 902 (FIG. 9). The central material closes a side of the garment, with each face of the garment having a symmetric inner and outer pattern formed by inner material 804 and two patterned edges 806 (one being inner and one being outer to the garment).

FIG. 9 is a simplified pictorial illustration of a side view of an unstitched seam product 800 used in garment 902, in accordance with an embodiment of the present invention. The garment comprises use silkscreen printed heat transfers to protect the edge of the garment. The heat transfer has properties of anti-slip and breathability. Heat transfers also have a decorative effect.

The heat transfers of the present invention are made using one or more of the following components:

1. Polyurethane Polymer;

2. Polyamide Polymer;

3. Acrylic Polymer;

4. Silicone;

5. Titanium dioxide;

6. Color Pigment;

7. Silicon dioxide powder;

8. Tin dioxide powder; and

9. Aluminum powder;

Production process description: Silkscreen printed transfers screen printed polymer. Many of them are suitable for the purpose and it depends on the fabric on which it will be applied. Some different samples in fact are different formulas, because they are made from different polymers or polymer combinations, as are known in the art. Also, the color and adhesive may contain one or more of polyethersulfone (PES), polyacrylamine (PA), Acryl and many others. The materials used in the present invention meet the requirements of the Ecotex100 standard, they are environmentally safe and safe for human use. Some are recyclable.

According to some embodiments, the carrier sheet may be a Framis polyurethane (PU) tape.
1. Application of patented PU trims enables to control elasticity of the part of the laminated fabric.
2. The transfers of the present invention are engineered to be cut with laser and make a soft fixed edge suitable for washing and wearing. The transfers of the present invention are both elastic and soft to the touch. Some of the transfers have a velvet-like feel. Others have a silk-like feel.
3. The products of the present invention may have three-dimensional appearance, be anti-slip, enable skin breathing, enable circulation of air or any other new solutions. The carrier paper may be specially adapted for anti-slip products. It may, for example provide a rough surface, a sticky surface, a non-slip surface to the transfers of the present invention.

The development of seal heat transfers of the present invention provides the following four properties simultaneously:—
1. Touch and a sense of delicate textile materials.
2. Very high elasticity—feels like a fabric by itself.
3. The extra thickness at an edge seam is negligible at the end of printed fabric technology. If for example the thickness of the fabric being tested is 0.2 mm after the transfer fabric laminate thickness of 0.25 mm will be an additional 0.05 mm, which can hardly be felt.
4. The addition of graphics and design using colored inks according to customer requirements, to provide logos, trademarks, patterns, flags and the like.

The special importance of the first three parameters is due to the engagement of underwear or sportswear with the body itself. This clothing design special professional technology users in order to give oneself a sense of maximum comfort, with almost no added thickness at leg seams. By using the described method, any stitches in the garment's seams are flattened out.

The references cited herein teach many principles that are applicable to the present invention. Therefore the full contents of these publications are incorporated by reference herein where appropriate for teachings of additional or alternative details, features and/or technical background. It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. An unstitched heat-transferable patterned seam product for sealing at least one edge and replacing a sewn edge seam in a garment, the seam product comprising an unstitched elastic heat-transferable patterned seam portion and at least one carrier element, wherein said unstitched heat-transferable patterned seam portion is adapted to be placed upside down over a garment edge and heat-transferred to said garment edge to provide an elastic seamed fabric-feel patterned garment edge adding less than 0.1 mm in thickness to said at least one edge.

2. An unstitched heat-transferable patterned seam product according to claim 1, wherein said unstitched elastic heat-transferable patterned seam portion comprises:
a) a lower ink layer comprising flock; and
b) an upper adhesive layer.

3. An unstitched heat-transferable patterned seam product according to claim 2, wherein said ink layer comprises at least two colors of ink.

4. An unstitched heat-transferable patterned seam product according to claim 3, wherein said ink layer comprises at least three colors of ink.

5. An unstitched heat-transferable patterned seam product according to claim 2, wherein said lower ink layer comprises at least one thermochromic ink.

6. An unstitched heat-transferable patterned seam product according to claim 2, wherein said upper adhesive layer comprises at least one heat-activatable adhesive.

7. An unstitched heat-transferable patterned seam product according to claim 6, wherein said upper adhesive layer has a thickness of about 10 to 400 microns.

8. An unstitched heat-transferable patterned seam product according to claim 6, wherein said lower ink layer has a thickness of about 10 to 800 microns.

9. An unstitched heat-transferable patterned seam product according to claim 6, wherein said heat-activatable adhesive layer comprises at least one of a polyester adhesive resin, a polyamide resin, and a polyurethane adhesive resin.

10. An unstitched heat-transferable patterned seam product according to claim 2, wherein said lower ink layer comprises at least one cross-linked polyurethane ink.

11. An unstitched heat-transferable patterned seam product according to claim 1, wherein said carrier element comprises a release layer selected from wax, a non-stick polymer, a non-wax, non-silicone, release material and combinations thereof.

12. An unstitched heat-transferable patterned seam product according to claim 1, wherein said at least one carrier element forms part of the seam product.

13. An unstitched heat-transferable patterned seam product according to claim 1, wherein said carrier element forms part of the seam product.

14. A method for forming an elasticated garment comprising:
a) cutting a piece of material to into a shape; and
b) heat transferring at least one unstitched elastic heat-transferable patterned seam product according to claim 2 onto said shape, thereby forming the garment.

15. A method according to claim 17, wherein steps a) and b) are repeated.

16. A method according to claim 18, further comprising;
c) sewing said pieces of material together in at least one place.

17. A garment formed according to the method of claim 15.

18. A garment formed according to the method of claim 16.

19. A garment according to claim 17, wherein said garment is seamless.

20. A garment according to claim 19, wherein said garment is selected from an underwear garment, a sportswear garment, panties, a slip and underpants.
